(19) United States
(12) Patent Application Publication
(10) Pub. No.: US 2014/0230425 A1
(43) Pub. Date: Aug. 21, 2014

(54) HYDRAULIC CIRCUIT FOR RAM CYLINDER

(71) Applicant: Yukio Uenishi, Minamikawachi-gun (JP)

(72) Inventor: Yukio Uenishi, Minamikawachi-gun (JP)

(73) Assignee: U-TEC CO., LTD., Osaka (JP)

(21) Appl. No.: 14/112,500

(22) PCT Filed: Apr. 12, 2012
(86) PCT No.: PCT/JP2012/060014

§ 371 Date: Jan. 14, 2014

(30) Foreign Application Priority Data
Apr. 18, 2011 (JP) 2011-092240
Apr. 6, 2012 (JP) 2012-087235

(51) Int. Cl. B30B 15/16

(52) U.S. Cl. CPC B30B 15/161
USPC 60/494

(57) ABSTRACT

A hydraulic circuit for a ram cylinder includes: a ram cylinder which drives a driven device; a hydraulic unit including (i) a supply circuit which includes a supply control valve and a supply throttle valve, and (ii) a discharge circuit which includes a discharge control valve and a discharge throttle valve; and a first supply/discharge circuit which connects the ram cylinder with the supply circuit of the hydraulic unit, and a second supply/discharge circuit which connects the ram cylinder with the discharge circuit of the hydraulic unit. A bypass circuit having an opening/closing function connects a portion downstream from the supply control valve and the supply throttle valve with a portion downstream from the discharge control valve and the discharge throttle valve, and the bypass circuit allows the first and second supply/discharge circuits to serve a plurality of functions.

### TECHNICAL FIELD

The present invention relates to a hydraulic circuit for a ram cylinder used in a device for driving a flap gate (bottom hinged), a spillway gate, and the like.

### BACKGROUND ART

In the above-mentioned hydraulic circuit for the ram cylinder, when hydraulic oil from a hydraulic power supplier is supplied to the ram cylinder, the ram cylinder extends, and thereby the gate is closed; and when a discharging side of the ram cylinder is opened toward an oil tank, a load applied to the ram cylinder (i.e., the weight of the gate) causes the ram cylinder to contract, and thereby the gate is opened. In these operations, the hydraulic oil in the ram cylinder, whose amount corresponds to the capacity of the ram cylinder, merely travels through pipes of the hydraulic circuit for the ram cylinder, and the hydraulic oil does not circulate therethrough. This has led to deterioration of the hydraulic oil, causing a malfunction of the hydraulic circuit.

One conventional art for solving the above problem in the hydraulic circuit for the ram cylinder is disclosed in Patent Literature 1. In a hydraulic circuit for a ram cylinder disclosed in Patent Literature 1, the ram cylinder is provided with a supply port and a discharge port, and the hydraulic circuit includes: a supply circuit which connects the supply port with an outlet of a hydraulic pump via a first poppet valve (supply-side control valve); and a discharge circuit which connects the discharge port to an oil tank via a second poppet valve (discharge-side control valve).

In the above arrangement disclosed in Patent Literature 1, hydraulic oil is supplied to the ram cylinder through the supply circuit by opening the supply-side control valve and closing the discharge-side control valve, to cause the ram cylinder to extend, whereas, the hydraulic oil for the ram of the ram cylinder is discharged through the discharge circuit by opening only the discharge-side control valve, to cause the ram cylinder to contract. Further, it is possible to perform flushing in the following manner: opening both of the supply-side control valve and the discharge-side control valve; and thereby causing the hydraulic oil discharged from the hydraulic pump to circulate through the supply-side control valve, a pressure chamber of the ram cylinder, and the discharge-side control valve, and then to return back to the tank.

### CITATION LIST

### Patent Literature

Patent Literature 1: Japanese Unexamined Patent Publication No. 2003-194009 (Tokukai 194009/2003)

### SUMMARY OF INVENTION

### Technical Problem

The supply circuit and the discharge circuit of the hydraulic circuit disclosed in the above-described Patent Literature 1 respectively function as the supply-side circuit and the discharge-side circuit individually in the above operations of the ram cylinder and in flushing. Therefore, the double pipes are for flushing only, and there is a defect that the double pipes do not perform a plurality of functions.

The present invention has been accomplished under the foregoing circumstances and has an object to allow double or more supply/discharge circuits connected to a ram cylinder to serve a plurality of functions, by causing the double or more supply/discharge circuits to work in cooperation with each other in lifting and lowering operations of the ram cylinder and in flushing operation.

### Solution to Problem

A hydraulic circuit for a ram cylinder of the present invention includes: the ram cylinder which drives a driven device such as a flap gate and a spillway gate; a hydraulic unit including (i) a supply circuit including a supply control valve which is connected to a discharging side of a hydraulic power supplier and controls supply of hydraulic oil discharged from the hydraulic power supplier, and a supply throttle valve which controls an amount of hydraulic oil supplied to the ram cylinder, and (ii) a discharge circuit including a discharge control valve which is connected to an oil tank and controls discharge of hydraulic oil returned from the ram cylinder, and a discharge throttle valve which controls an amount of hydraulic oil returned from the ram cylinder; a first supply/discharge circuit which connects the ram cylinder with the supply circuit of the hydraulic unit and a second supply/discharge circuit which connects the ram cylinder with the discharge circuit of the hydraulic unit; and a bypass circuit which connects (i) a portion of the supply circuit of the hydraulic unit that portion is downstream from the supply control valve and the supply throttle valve and (ii) a portion of the discharge circuit that portion is downstream from the discharge control valve and the discharge throttle valve, the bypass circuit including a stop valve having an opening/closing function. The hydraulic circuit further includes: a flushing circuit for flushing the ram cylinder, the flushing circuit established when the bypass circuit closes communication between the supply circuit of the hydraulic unit and the discharge circuit of the hydraulic unit; and a driving circuit for driving the ram cylinder, the driving circuit established when the bypass circuit establishes communication between the supply circuit of the hydraulic unit and the discharge circuit of the hydraulic unit.

With the present invention having the above structure, the bypass circuit is arranged so as to connect the portion of the supply circuit of the hydraulic unit that portion is downstream from the supply control valve and the supply throttle valve with the portion of the discharge circuit that portion is downstream from the discharge control valve and the discharge throttle valve. Therefore, when the stop valve of the bypass circuit is opened, the first supply/discharge circuit and the second supply/discharge circuit are connected in the hydraulic unit, and this allows the first supply/discharge circuit and the second supply/discharge circuit to supply/discharge hydraulic oil to/from the ram cylinder in cooperation with each other. Accordingly, if one of the supply/discharge circuits is damaged in disaster situations etc., the other one of the supply/discharge circuits can be used for operations of the ram cylinder, and this hydraulic circuit is safer in the disaster situations. Further, it is possible to assign a plurality of functions to the double or more supply/discharge circuits. For example, by closing the stop valve of the bypass circuit, a flushing is performed, in which hydraulic oil is supplied to and discharged from the ram cylinder through the first supply/discharge circuit and the second supply/discharge circuit, respectively. Furthermore, since the double or more supply/discharge circuits work in cooperation with each other, the diameter of their pipes may be decreased, and this provides an advantageous effect of reducing the cost for the pipes.

In the above structure, the bypass circuit including the stop valve, the supply control valve, and the discharge control valve are provided in the hydraulic unit. This enables an operator to perform flushing at the installation site of the hydraulic unit without going to the installation site of the flap gate or the spillway gate. This provides an advantageous effect of improving work efficiency.

Furthermore, in the hydraulic circuit of the present invention, the supply circuit includes a detour circuit which bypasses the supply control valve and the supply throttle valve, the detour circuit including a stop valve; and the discharge circuit includes a detour circuit which bypasses the discharge control valve and the discharge throttle valve, the detour circuit including a stop valve.

In the above structure, both detour circuits detour hydraulic oil discharged in flushing around the supply control valve and the supply throttle valve; and the discharge control valve and the discharge throttle valve, respectively. This provides an advantageous effect of preventing malfunctions of the equipment of the hydraulic unit due to contamination with dust or the like.

Further, in the hydraulic circuit of the present invention, each of the first supply/discharge circuit and the second supply/discharge circuit which are downstream from the bypass circuit includes a plurality of stop valves each including a multi-purpose port having an opening/closing function and an automatic closing function.

The above structure provides the following advantageous effect: even if either one of the first supply/discharge circuit and the second supply/discharge circuit is damaged to cause oil leakage, it is possible to operate the ram cylinder by closing the stop valves located upstream and downstream from the portion at which the leakage occurs and by using the other supply/discharge circuit and another detour circuit which bypasses the damaged portion and which is established using the multi-purpose port. Further, even if both of the first and second supply/discharge circuits are damaged, the operations of the ram cylinder are secured by: closing the stop valves located upstream and downstream from the respective damaged portions; and connecting detour circuits for bypassing the respective damaged portions to the multi-purpose ports of the closed stop valves.

Advantageous Effects of Invention

The hydraulic circuit for the ram cylinder of the present invention is configured so that: hydraulic oil is supplied to/discharged from the ram cylinder through the plurality of supply/discharge circuits; and opening and closing of each of the supply/discharge circuits is arbitrarily performed using the stop valve of the bypass circuit. Therefore, various advantageous effects are brought about. For example, operations of the ram cylinder is performed using one supply/discharge circuit if the other supply/discharge circuit cannot be used, and maintenance of the hydraulic circuit is made easily and reliably.

### BRIEF DESCRIPTION OF DRAWINGS

FIG. 1 is a circuit diagram of a hydraulic circuit for a ram cylinder of one embodiment of the present invention.

FIG. 2(a) is a sectional view of a stop valve used in a hydraulic circuit of one embodiment of the present invention.

FIG. 2(b) is a sectional view of a joint used in a hydraulic circuit of one embodiment of the present invention.

FIG. 3 is a diagram for explaining a lifting operation of the ram cylinder.

FIG. 4 is a diagram for explaining a lowering operation of the ram cylinder.

FIG. 5 is a diagram for explaining a flushing operation.

### DESCRIPTION OF EMBODIMENTS

The following describes preferred embodiments of the present invention.

(Hydraulic Circuit and Ram Cylinder)

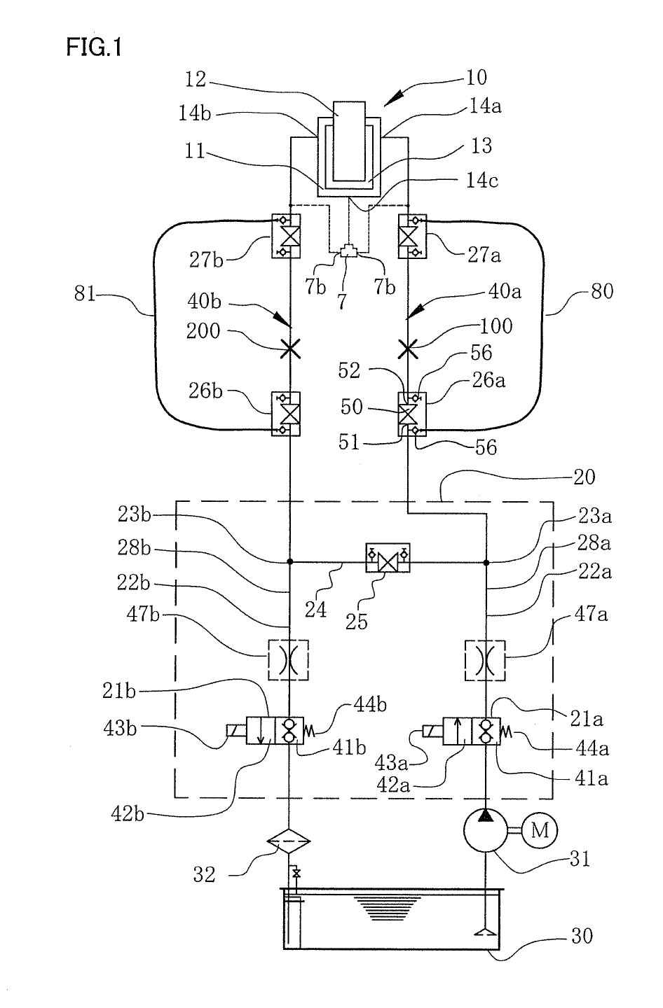

In FIG. 1, which shows a hydraulic circuit for a ram cylinder, a ram cylinder 10 for driving a driven device such as a flap gate, a spillway gate, or the like includes a cylinder body 11 and a ram 12. The ram 12 which protrudes beyond an upper end of the cylinder body 11 and is configured to push the driven device upward is slidably fitted in the cylinder body 11. The cylinder body 11 has a hydraulic chamber 13 including a first inlet/outlet port 14a and a second inlet/outlet port 14b. The ram cylinder 10 operates in the following manner: when hydraulic oil is supplied through the first inlet/outlet port 14a and the second inlet/outlet port 14b to the hydraulic chamber 13, the ram 12 is lifted together with the driven device; and when the hydraulic oil in the hydraulic chamber 13 is discharged through the first inlet/outlet port 14a and the second inlet/outlet port 14b, the ram 12 is lowered by the weight of the driven device.

As shown in FIG. 1, in the above-described structure, the two inlet/outlet ports, which are the first inlet/outlet port 14a and the second inlet/outlet port 14b, are provided to the cylinder body 11; however, another structure is also possible. As indicated with broken lines in FIG. 1, a single third inlet/outlet port 14c maybe coupled with a tee joint 7 having two ports 7a and 7b, to which a first supply/discharge circuit 40a and a first supply/discharge circuit 40b are respectively connected.

(Hydraulic Unit)

A hydraulic unit 20 includes a supply circuit 22a and a discharge circuit 22b. The supply circuit 22a is connected to a discharging side of a hydraulic power supplier (hereinafter referred to as a “hydraulic pump 31”) which sucks hydraulic oil in an oil tank 30. The supply circuit 22a includes a supply control valve 21a and a supply throttle valve 47a and has a supply circuit portion 28a connected with the first supply/discharge circuit 40a connected to the ram cylinder 10. The discharge circuit 22b has a discharge circuit portion 28b with which the second supply/discharge circuit 40b for the ram cylinder 10 is connected, and the discharge circuit 22b includes a discharge throttle valve 47b which controls the lowering speed in the ram cylinder 10, and a discharge control valve 21b.

A bypass circuit 24 including a stop valve 25 is connected with a connection point 23a of the supply circuit portion 28a which is the portion of the above-described supply circuit 22a that portion is downstream from the supply control valve 21a and the supply throttle valve 47a. (Note that “downstream from the valves” means that the portion is located closer to the ram cylinder 10 than these valves, and “downstream” will be used hereinbelow in the same way.) The bypass circuit 24 is also connected with a connection point 23b of the discharge circuit portion 28b which is the portion of the above-described discharge circuit 22b that portion is downstream from the discharge control valve 21b and the discharge throttle valve 47b (i.e., the portion is located closer to the ram cylinder 10 than these valves), and which is connected with the second supply/discharge circuit 40b.

(Hydraulic Circuit)

When the supply control valve 21a allows the supply circuit 22a of the hydraulic unit 20 to communicate with the discharging side of the hydraulic pump 31, hydraulic oil is supplied to the ram cylinder 10 through the supply circuit portion 28a and the first supply/discharge circuit 40a while the flow rate of the hydraulic oil is controlled by the supply throttle valve 47a so that the ram cylinder 10 operates at a predetermined speed. Meanwhile, when the discharge control valve 21b allows the discharge circuit 22b of the hydraulic unit 20 to communicate with the oil tank 30, the oil discharged from the ram cylinder 10 passes through the second supply/discharge circuit 40b and the discharge circuit portion 28b and is discharged to the oil tank 30 while the returning hydraulic oil is controlled by the discharge throttle valve 47b so that the lowering speed is a predetermined speed.

Assuming that this system is applied to a device for driving a flap gate which controls water flow in a river, the distance between the hydraulic unit 20 and the ram cylinder 10 corresponds to the length of the flap gate (nearly equal to the width of the river), and therefore, the first supply/discharge circuit 40a and the second supply/discharge circuit 40b each connected with the ram cylinder 10 have a long length. Note that, the same applies to other facilities, so the length of each of the first supply/discharge circuit 40a and the second supply/discharge circuit 40b connecting the ram cylinder 10 with the hydraulic unit 20 is usually long.

When the stop valve 25 is opened, the bypass circuit 24 enables the hydraulic oil supplied to the supply circuit portion 28a to be supplied to the second supply/discharge circuit 40b through the connection point 23a, the stop valve 25, and the connection point 23b. Thus, the hydraulic oil is supplied to the ram cylinder 10 through both of the first supply/discharge circuit 40a and the second supply/discharge circuit 40b.

Meanwhile, when the stop valve 25 is opened, the bypass circuit 24 enables the oil discharged from the ram cylinder 10 to reach the discharge circuit 22b through the first supply/discharge circuit 40a, the connection point 23a, the stop valve 25, and the connection point 23b. Thus, the oil discharged from the ram cylinder 10 is discharged through both of the first supply/discharge circuit 40a and the second supply/discharge circuit 40b.

As described above, when the bypass circuit 24 is opened by opening the stop valve 25, hydraulic oil is supplied to/discharged from the ram cylinder 10 using both of the first supply/discharge circuit 40a and the second supply/discharge circuit 40b. Therefore, the diameter of the pipes for the first supply/discharge circuit 40a and the second supply/discharge circuit 40b, each of which circuits constituted by a single pipe, is approximately 70% the size of the diameter of the pipes for the supply circuit 22a and the discharge circuit 22b. The decrease in the diameter of the pipes brings about an advantageous effect of a significant reduction in the cost of the first supply/discharge circuit 40a and the second supply/discharge circuit 40b, each of which has to have the long length extending from the hydraulic unit 20 to the ram cylinder 10.

Note that, when the stop valve 25 of the bypass circuit 24 is closed, cooperation between the first supply/discharge circuit 40a and the second supply/discharge circuit 40b ends, and therefore, the first supply/discharge circuit 40a and the second supply/discharge circuit 40b function individually without cooperating with each other.

The hydraulic unit 20 may include a filter 32, the oil tank 30, and the hydraulic pump 31; however, the structure of the hydraulic unit 20 is not limited thereto as long as the hydraulic unit 20 has the following structure: at least the supply control valve 21a and the discharge control valve 21b are included; the stop valve 25 is provided in the vicinity of the supply control valve 21a and the discharge control valve 21b; and the supply control valve 21a, the discharge control valve 21b, and the stop valve 25 are controllable at the installation site of the hydraulic unit 20.

(Supply Control Valve and Discharge Control Valve)

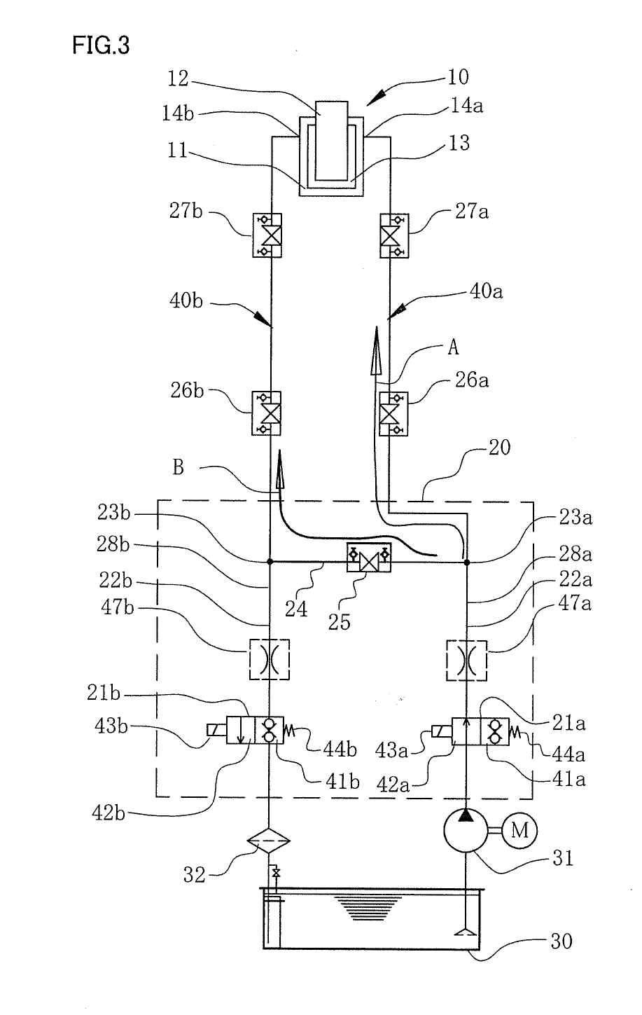

Description will be given for the supply control valve 21a and the discharge control valve 21b. The supply control valve 21a and the discharge control valve 21b have the same structure, and therefore, the structure of one of them will be described. As for the other one, corresponding elements have the same reference numerals with a different alphabet letter appended thereto, and the description thereof will be given if needed. The supply control valve 21a includes a closed position 41a, an open position 42a, a solenoid portion 43a and a return spring 44a. The supply control valve 21a includes a poppet function, and in the closed position 41a, the poppet function blocks the flow from the ram cylinder 10 to the hydraulic pump 31 in the supply circuit 22a and maintains a hydraulic pressure. (Since the details of this structure are illustrated in FIG. 3 of Patent Literature 1 and described therein, the description thereof is omitted here.) When an operation signal is applied to the solenoid portion 43a of the supply control valve 21a to cause the supply control valve 21a to be in the open position 42a, the discharging side of the hydraulic pump 31 communicates with the supply circuit 22a. The supply control valve 21a is configured so that: the supply control valve 21a is held in the closed position 41a by the return spring 44a when no operation signal is applied to the solenoid portion 43b; and the supply control valve 21a is caused to be in the open position 42a when an operation signal is applied to the solenoid portion 43a. Note that the term “to cause” may be used not only when an operation signal is applied to the solenoid portion 43a and but also when the application of the operation signal is stopped.

(Stop Valve)

Stop valves 25, 26a, 27a, and 29a, and stop valves 26b, 27b, and 29b have the same structure, and therefore, description will be given for the stop valve 26a. As for each of the other stop valves, corresponding elements have the same reference numerals with a different alphabet letter appended thereto, and the description thereof will be given if needed.

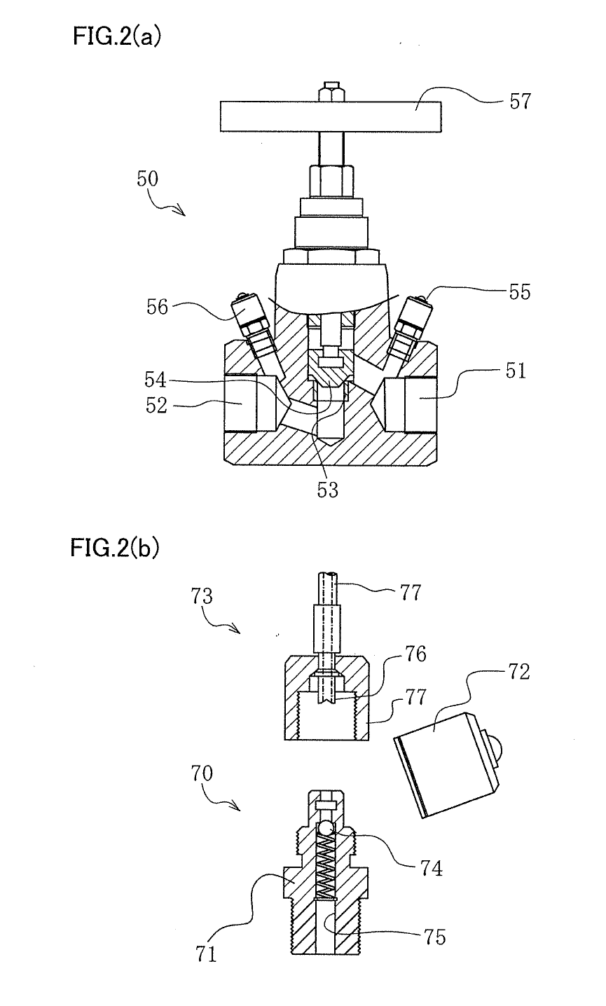

The specific structure of the stop valves 25, 26a, 27a, and 29a, and the stop valves 26b, 27b, and 29b is as follows. As shown in FIG. 2(a), each of the stop valves includes: ports 51 and 52 which are provided to a stop valve body 50 and are to be connected with the hydraulic circuit; a valve seat 53 with which the ports 51 and 52 are connected; a valve portion 54 which is positioned so as to face the valve seat 53 and establishes/closes communication between the port 51 and the port 52; and multi-purpose ports 55 and 56 communicating with the port 51. A joint 70 having an automatic closing function is attached to each of the ports 55 and 56. Each stop valve is configured so that the valve portion 54 is lifted/lowered using a handle 57.

(Joint)

The joint 70 shown in FIG. 2(b) includes: a joint body 71 to be attached to the stop valve body 50; a cap 72 which protects a leading end of the joint body 71; and a joint fitting 73 which is attached to the joint body 71 to cancel the closing function of the joint body 71. The joint body 71 includes a check valve 74 and a passage 75 communicating with the port 51. An upper end of the passage 75 is open, and a protrusion 76 of the joint fitting 73 is configured to be inserted into the open end. Note that, as for the reference signs of the elements of the stop valves 25, 26a, 27a, and 29a, and the stop valves 26b, 27b, and 29b shown in FIGS. 1, 3, 4, and 5, the specific structure shown in FIG. 2(a) is illustrated on the stop valve 26a of FIG. 1, and corresponding elements of each of the other stop valves will be given the same reference signs as those of the stop valve 26a. Illustration of the other valves is omitted here.

The joint fitting 73 has the following structure: the protrusion 76 is protruded from a lower portion of the joint fitting 73; the joint fitting 73 is to be screwed to an upper end of the joint body 71; and a hose 77 to which equipment such as an pressure gage and a fitting is connected is attached to the joint fitting 73. The joint body 71 is configured so that, when the joint fitting 73 is attached, its protrusion 76 opens the check valve 74 thereby causing the passage 75 to communicate with the hose 77. That is, in the state where the joint fitting 73 is not attached, the joint body 71 has the automatic closing function by which the check valve 74 closes the passage 75.

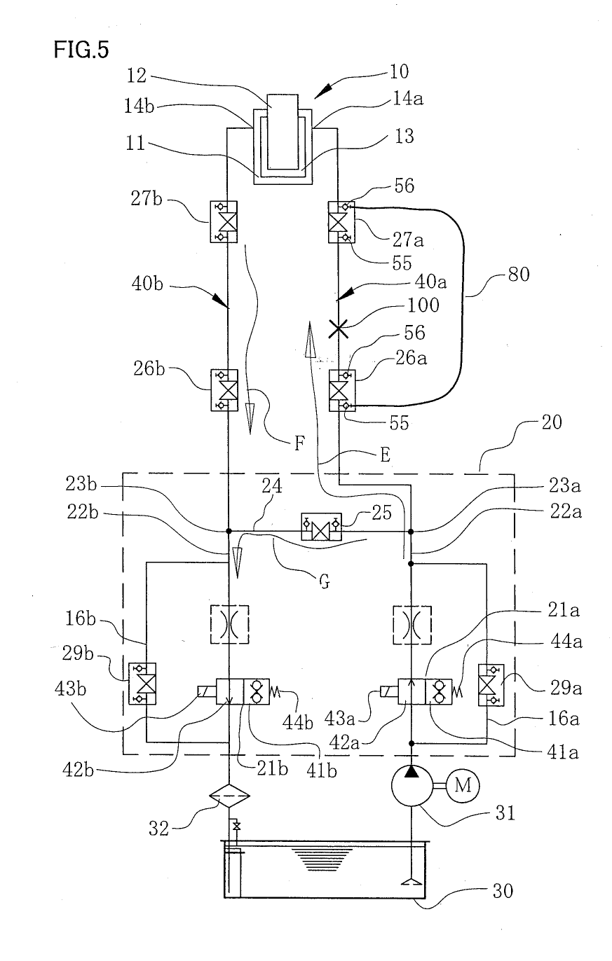

In the above-described embodiment, the stop valve 25 of the bypass circuit 24, the stop valve 29a of a detour circuit 16a, and the stop valve 29b of a detour circuit 16b (the stop valves 29a and 29B are shown in FIG. 5) have the same structure as that of the stop valves 26a, 26b, 27a, and 27b, as illustrated using the same reference signs. However, in the stop valves 25, 29a, and 29b, the usage of the multi-purpose ports 55 and 56 is extremely low, and therefore, the multi-purpose ports 55 and 56 maybe omitted from these valves to function as simple stop valves.

(Description of Operations)

The following describes the operations of the hydraulic circuit for the ram cylinder of this embodiment.

(Lifting and Stopping Operations of Ram 12)

Referring to FIG. 3, when the supply control valve 21a is controlled to be in the open position 42a and the discharge control valve 21b is controlled to be in the closed position 41b, hydraulic oil discharged from the hydraulic pump 31 flows into the hydraulic chamber 13 through the supply circuit 22a and the first supply/discharge circuit 40a, as indicated with an arrow A. Simultaneously, as indicated with an arrow B, the hydraulic oil flows into the hydraulic chamber 13 through the supply circuit 22a, the connection point 23a, the stop valve 25, the bypass circuit 24, and the second supply/discharge circuit 40b. As a result, the ram 12 of the ram cylinder 10 is lifted. When the supply control valve 21a is controlled to be in the closed position 41a during the above lifting operation, the ram 12 of the ram cylinder 10 is stopped in the position it takes at that time since the discharge circuit 22b and the supply circuit 22a are closed.

When the stop valve 25 is closed to close the bypass circuit 24 during the above lifting operation of the ram cylinder 10, the flow of the hydraulic oil indicated with the arrow B is stopped, and the hydraulic oil discharged from the hydraulic pump 31 flows into the hydraulic chamber 13 through the supply circuit 22a and the first supply/discharge circuit 40a as indicated with the arrow A, so that the ram 12 is lifted. As a result, the amount of hydraulic oil supplied to the hydraulic chamber 13 is decreased, and the lifting speed is also decreased. (Note that, in this embodiment, the cross section of each of the pipes for the first supply/discharge circuit 40a and the second supply/discharge circuit 40b is approximately 70% the size of the cross section of each of the pipes for the supply circuit 22a and the discharge circuit 22b.)

(Lowering and Stopping Operations of Ram 12)

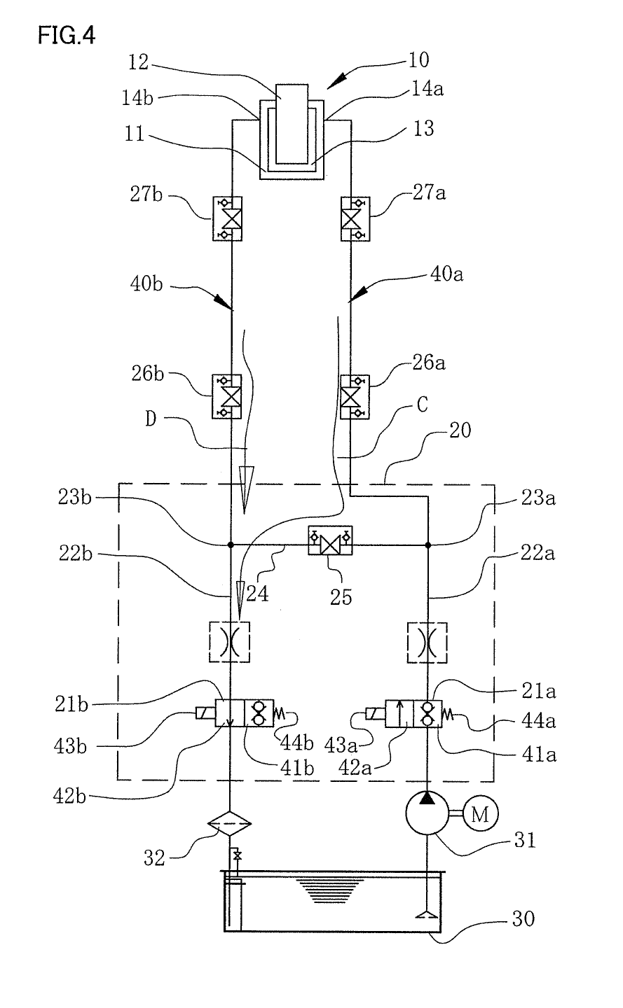

Referring to FIG. 4, when the supply control valve 21a is controlled to be in the closed position 41a and the discharge control valve 21b is controlled to be in the open position 42b, the flow from the discharging side of the hydraulic pump 31 is blocked by the supply control valve 21a, and due to a load applied to the ram 12, the hydraulic oil in the hydraulic chamber is returned to the oil tank 30 through the first supply/discharge circuit 40a, the second supply/discharge circuit 40b, the discharge circuit 22b, and the discharge control valve 21b, as indicated with arrows C and D. Consequently, the ram 12 of the ram cylinder 10 is lowered. When the discharge control valve 21b is controlled to be in the closed position 41b during this operation, the ram 12 being lowered is stopped since the discharge circuit 22b and the supply circuit 22a are closed. (Note that the supply control valve 21a is in the closed position 41a from the beginning of the operation).

When the stop valve 25 is closed to close the bypass circuit 24 during the above lowering operation of the ram 12, the hydraulic oil from the hydraulic chamber 13 of the ram cylinder 10 flows to the oil tank 30 through the second supply/discharge circuit 40b and the discharge circuit 22b as indicated with the arrow D, and therefore, the amount of hydraulic oil discharged from the hydraulic chamber 13 is decreased, and the lowering speed is also decreased.

(Flushing)

Referring to FIG. 5, flushing for cleaning the supply circuit 22a, the discharge circuit 22b, the first supply/discharge circuit 40a, and the second supply/discharge circuit 40b, which circuits constitute the hydraulic circuit, is performed in the following manner: the stop valve 25 is closed, and the supply control valve 21a and the discharge control valve 21b are controlled to be in the open positions 42a and 42b respectively, so that the hydraulic oil discharged from the hydraulic pump 31 is supplied to the supply circuit 22a; the hydraulic oil passes through the first supply/discharge circuit 40a as indicated with the arrow E, and then passes through the hydraulic chamber 13; and thereafter, the hydraulic oil is returned to the oil tank 30 through the second supply/discharge circuit 40b and the discharge control valve 21b as indicated with the arrow F. At the time of flushing, hydraulic oil flows into the hydraulic chamber 13 of the ram cylinder 10 and presses the ram 12; however, the ram 12 is held at a lowered position by the load applied thereto. Further, in this flushing operation, all the hydraulic oil discharged from the hydraulic pump 31 passes through the circuits other than the bypass circuit 24, and therefore, the effect of flushing is greater.

Aside from the above flushing operation, when the supply control valve 21a and the discharge control valve 21b are controlled to be in the open positions 42a and 42b, respectively, and the stop valve 25 of the bypass circuit 24 is opened to open the bypass circuit 24, the hydraulic oil discharged from the hydraulic pump 31 passes, as indicated with an arrow G, through the supply circuit 22a, the bypass circuit 24, the discharge circuit 22b, and the discharge control valve 21b, and then the hydraulic oil returns back to the oil tank 30. In this case, the amount of hydraulic oil flowing through the first supply/discharge circuit 40a, the hydraulic chamber 13, and the second supply/discharge circuit 40b (the flow of the hydraulic oil indicated with the arrows E and F) is smaller; however, flushing is performed on the whole hydraulic circuit and the hydraulic chamber 13, at the same time.

### Second Embodiment

A second embodiment shown in FIG. 5 is characterized in that the hydraulic circuit includes (i) a detour circuit 16a which bypasses the supply control valve 21a and the supply throttle valve 47a, and includes the stop valve 29a; and (ii) a detour circuit 16b which bypasses the discharge control valve 21b and the discharge throttle valve 47b, and includes the stop valve 29b. At the time of flushing, the detour circuit 16a functions to bypass the supply control valve 21a and the supply throttle valve 47a, and the detour circuit 16b functions to bypass the discharge control valve 21b and the supply throttle valve 47a. Therefore, when flushing is performed in the state where the supply control valve 21a and the discharge control valve 21b are in the closed positions 41a and 41b respectively, and the stop valves 29a and 29b are opened, the supply control valve 21a and the supply throttle valve 47a, and the discharge control valve 21b and the discharge throttle valve 47b are protected from contamination in the contaminated hydraulic oil. In the above description, since merely the hydraulic oil discharged from the hydraulic pump 31 passes through the detour circuit 16a, the supply control valve 21a is not subjected to the contamination; however, the stop valve 29a in place of the supply control valve 21a has a simpler structure, and this decreases the resistance in the flow of the hydraulic oil. Accordingly, the detour circuit 16a may be omitted.

As described above, through flushing of the hydraulic circuit, a large amount of hydraulic oil is supplied to a section of the hydraulic chamber 13 that is likely to be contaminated with dust or the like, and therefore contamination is removed intensively. Further, by providing and opening the detour circuits, contamination does not pass through the complicated equipment such as the supply control valve 21a and the discharge control valve 21b. This provides an advantageous effect of preventing troubles in the equipment caused by the contamination.

(Operability of Stop Valve 25)

Further, since the stop valve 25 is provided in the hydraulic unit 20 and between (i) the supply circuit portion 28a downstream from the supply control valve 21a and the supply throttle valve 47a and (ii) the discharge circuit portion 28b downstream from the discharge control valve 21b and the discharge throttle valve 47b, the operations on the supply control valve 21a and the discharge control valve 21b, and the operation on the stop valve 25 are performed at the installation site of the hydraulic unit 20. This eliminates the necessity to go to a position near the ram cylinder 10 installed far away, and this provides an advantageous effect of improving work efficiency. Furthermore, instead of the stop valve 25, a solenoid-type control valve like the supply control valve 21a may be provided. In the case of the solenoid-type valve, all the operations are able to be made through the solenoid, and therefore its operability is further improved.

(Damage Repair)

Referring to FIG. 1, if damage is caused by aging or an earthquake or the like at a portion 100 of the first supply/discharge circuit 40a, the stop valve 26a and the stop valve 27b respectively located upstream and downstream from the portion 100 are controlled to be in the closed positions, and thereby the flow indicated with the arrow A is blocked, so that as indicated with the arrow B, hydraulic oil is supplied to the ram cylinder 10 through the supply circuit 22a, the bypass circuit 24, and the second supply/discharge circuit 40b. With this, the operations of the ram cylinder 10 are secured.

Further, when the stop valve 26a and the stop valve 27a are closed due to the damage of the portion 100, the first supply/discharge circuit 40a is closed; however, it is possible to conduct the lowering operation of the ram cylinder 10 since the hydraulic oil in the hydraulic chamber 13 is returned to the oil tank 30 through the second supply/discharge circuit 40b and the discharge circuit 22b (as indicated with the arrow D of FIG. 4).

Moreover, when the stop valve 26a and the stop valve 27a are closed due to the damage of the portion 100, the flow indicated with the arrow E is blocked and therefore the above flushing operation cannot be performed on the hydraulic circuit for the ram cylinder 10. However, it is possible to perform flushing using a detour hose 80 made by attaching the joint fittings 73 to the both ends of the hose 77. The detour hose 80 is connected to the multi-purpose port 55 of the stop valve 26a and the multi-purpose port 56 of the stop valve 27a.

Further, as shown in FIG. 1, if a portion 200 is also damaged in addition to the portion 100, the operations of the ram cylinder 10 are secured by providing the detour hose 80 and a detour hose 81 which respectively bypass the portion 100 and the portion 200. If various types of gates such as a flap gate and a spillway gate do not work, tremendous damage is caused in their downstream areas. Securing the operations of the gates as in the present invention advantageously decreases the damage in the downstream areas.

### Reference Signs List

10 Ram cylinder
11 Cylinder body
12 Ram
14a Inlet/outlet port
14b Inlet/outlet port
21a Supply control valve
21b Discharge control valve
22a Supply circuit
22b Discharge circuit
24 Bypass circuit
25 Stop valve
26a, 27a, 29a Stop valve
26b, 27b, 29b Stop valve
30 Oil tank
31 Hydraulic pump
40a First supply/discharge circuit
40b Second supply/discharge circuit
51 Port
52, 53 Port
54 Valve portion
55, 56 Multi-purpose port
70 Joint
71 Joint body
72 Cap
73 Joint fitting

1. A hydraulic circuit for a ram cylinder, the hydraulic circuit comprising:
the ram cylinder which drives a driven device such as a flap gate and a spillway gate;
a hydraulic unit including (i) a supply circuit including a supply control valve which is connected to a discharging side of a hydraulic power supplier and controls supply of hydraulic oil discharged from the hydraulic power supplier, and a supply throttle valve which controls an amount of hydraulic oil supplied to the ram cylinder, and (ii) a discharge circuit including a discharge control valve which is connected to an oil tank and controls discharge of hydraulic oil returned from the ram cylinder, and a discharge throttle valve which controls an amount of hydraulic oil returned from the ram cylinder;
a first supply/discharge circuit which connects the ram cylinder with the supply circuit of the hydraulic unit and a second supply/discharge circuit which connects the ram cylinder with the discharge circuit of the hydraulic unit; and
a bypass circuit which connects (i) a portion of the supply circuit of the hydraulic unit that portion is downstream from the supply control valve and the supply throttle valve and (ii) a portion of the discharge circuit that portion is downstream from the discharge control valve and the discharge throttle valve, the bypass circuit including a stop valve having an opening/closing function,
wherein the hydraulic circuit further comprises:
a flushing circuit for flushing the ram cylinder, the flushing circuit established when the bypass circuit closes communication between the supply circuit of the hydraulic unit and the discharge circuit of the hydraulic unit; and
a driving circuit for driving the ram cylinder, the driving circuit established when the bypass circuit establishes communication between the supply circuit of the hydraulic unit and the discharge circuit of the hydraulic unit.

2. (canceled)

3. The hydraulic circuit according to claim 1, wherein: the supply circuit includes a detour circuit which bypasses the supply control valve and the supply throttle valve, the detour circuit including a stop valve; and the discharge circuit includes a detour circuit which bypasses the discharge control valve and the discharge throttle valve, the detour circuit including a stop valve.

4. (canceled)

5. The hydraulic circuit according to claim 1, wherein each of the first supply/discharge circuit and the second supply/discharge circuit which are downstream from the bypass circuit includes a plurality of stop valves each including a multi-purpose port having an opening/closing function and an automatic closing function.
